(19) United States
(12) Patent Application Publication
(10) Pub. No.: US 2013/0112279 A1
(43) Pub. Date: May 9, 2013

(54) HOT MELTING SYSTEM

(71) Applicant: Graco Minnesota Inc., Minneapolis, MN (US)

(72) Inventors: Daniel P. Ross, Maplewood, MN (US); Paul R. Quam, Brooklyn Center, MN (US)

(73) Assignee: GRACO MINNESOTA INC., Minneapolis, MN (US)

(21) Appl. No.: 13/660,079

(22) Filed: Oct. 25, 2012

Related U.S. Application Data
(60) Provisional application No. 61/556,561, filed on Nov. 7, 2011.

(51) Int. Cl. F16L 53/00

(52) U.S. Cl. 137/13; 137/334

(57) ABSTRACT

A system for melting adhesive comprises a melter, a feed system, a pump, and a controller. The melter has a melting volume, and receives and melts adhesive. The feed system supplies unmelted adhesive to the melter, while the pump pumps melted adhesive from the melter. The controller directs the pump to pump melted adhesive at a throughput rate such that the ratio of the melting volume to the throughput rate is a dwell time less than a discoloration time of the adhesive. In some embodiments, the controller also directs the feed system to replenish adhesive in the melter as a function of adhesive level in the melter.

### CROSS-REFERENCE TO RELATED APPLICATION(S)

This application is a non-provisional application of U.S. application Ser. No. 61/556,561, filed on Nov. 7, 2011.

### BACKGROUND

The present disclosure relates generally to systems for dispensing hot melt adhesive. More particularly, the present disclosure relates to an adhesive dispensing system with an integrated feed system.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

According to the present invention, a system for melting adhesive comprises a melter, a feed system, a pump, and a controller. The melter has a melting volume, and receives and melts adhesive. The feed system supplies unmelted adhesive to the melter, while the pump pumps melted adhesive from the melter. The controller directs the pump to pump melted adhesive at up to a maximum throughput rate such that the ratio of the melting volume to the maximum throughput rate is a minimum dwell time less than a discoloration time of the adhesive. In some embodiments, the controller also directs the feed system to replenish adhesive in the melter as a function of adhesive level in the melter.

### BRIEF DESCRIPTION OF THE DRAWINGS

FIG. 1 is a schematic view of a system for dispensing hot melt adhesive.

FIG. 2 is a simplified cross-sectional view of a melter and surrounding elements of the system of FIG. 1

### DETAILED DESCRIPTION

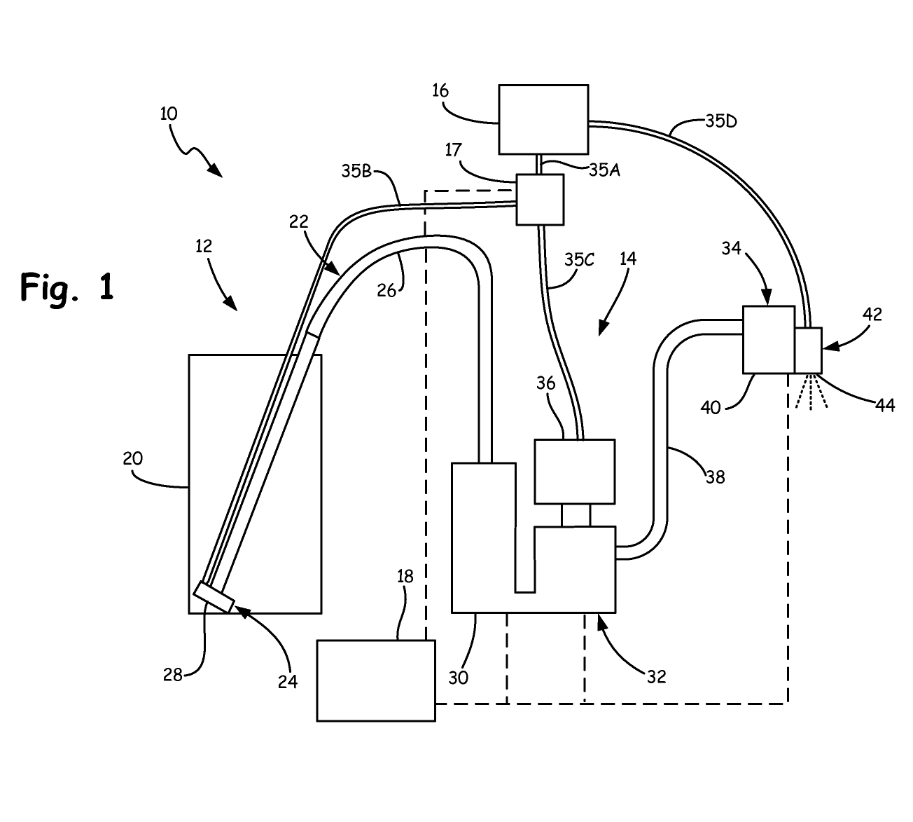

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and dispensing module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

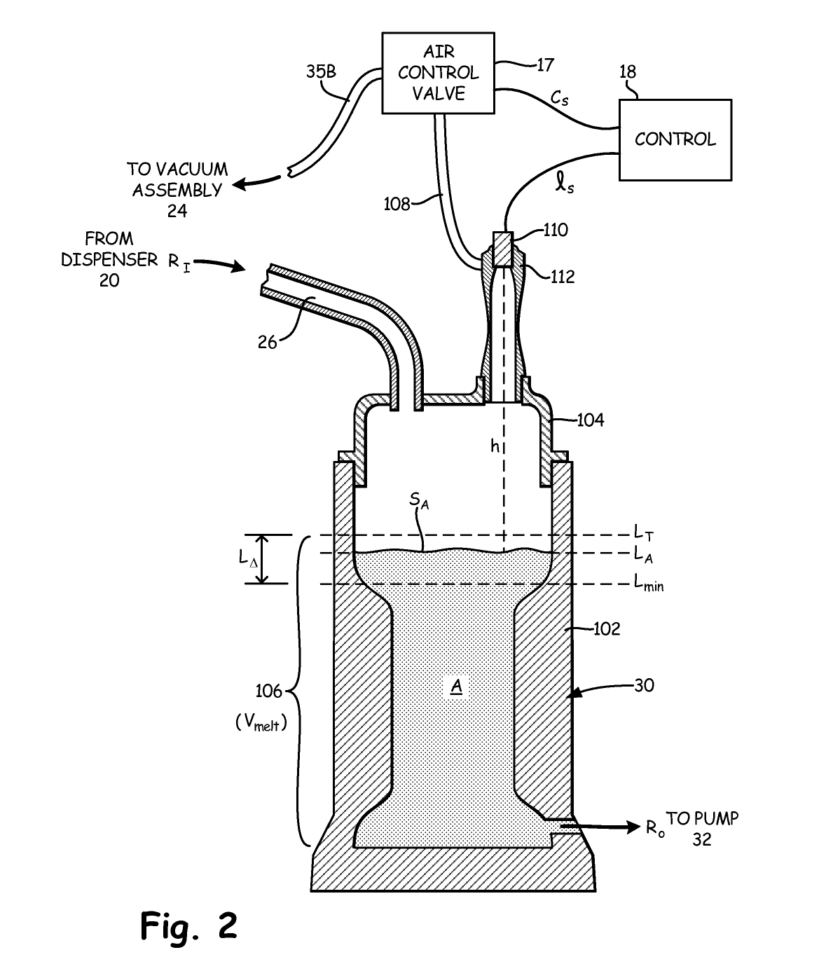

FIG. 2 is a cross-sectional view of melt system 30 and surrounding components. FIG. 2 illustrates air control valve 17, controller 18, feed hose 26, melt system 30, and air hoses 35B and 108. Melt system 30 comprises melter 102 (with melting region 106), cover 104, sensor 110, and sensor housing 112.

Melter 102 is an adhesive receptacle capable of containing and melting solid adhesive received from dispenser 20. Melter 102 has melting region 106, a heated region with melting volume Vₘₑₗₜ wherein solid adhesive is melted before being pumped by pump 32 to dispenser 34. Melting region 106 may, for instance, be a region of melter 102 provided with a plurality of resistive heating elements. Adhesive pellets from feed hose 26 accumulate within melter 102 to form a body of melting adhesive A. As adhesive A melts, a substantially flat adhesive surface S_{A} develops at adhesive level L_{A} within melter 102.

Cover 104 is a rigid cap configured to fit atop melter 102 to protect operators against hot melt splatter, and to anchor feed hose 26 and sensor housing 112. In some embodiments, cover 104 may include one or more vents or air passages (not shown) to let out air from feed hose 26. Sensor housing 112 supports level sensor 110 at a distance from adhesive surface S_{A} and receives cooling airflow via air hose 108 to protect level sensor 110 from spatter, heat, and dust. Although FIG. 2 depicts air hose 108 as drawing air from air control valve 17, alternative embodiments of system 10 may route air hose 108 directly from air source 16 (see FIG. 1). Level sensor 110 is an ultra-sonic transducer that emits ultrasonic pulses and receives return pulses reflected back from adhesive surface S_{A}. Adhesive level L_{A} (or height h, a vertical distance between level sensor 110 and adhesive surface S_{A}) can be determined from the time of travel of the pulses from sensor 110 to surface S_{A} and back to sensor 110. In some embodiments, level sensor 110 may be configured to produce a level signal lₛ indicating adhesive level L_{A}. In other embodiments, level sensor 110 may be configured to pass raw sensor data corresponding to height h to controller 18, which then determines adhesive level L_{A} from this sensor data.

Controller 18 commands air control valve 17 to maintain a flow of adhesive through melter 102 by providing air to vacuum assembly 24 via air hose 35B and to pump 32 via air hose 35C (see FIG. 1). Solid adhesive pellets from feed hose 26 enter melter 102 at input rate R_{I} determined by the frequency and duration of air pulses sent to vacuum assembly 24 by air control valve 17. Similarly, pump 32 pumps hot melt adhesive out of melter 102 at output rate R_{O} determined by a pump cycle set by airflow from air control valve 17 to air motor 36. On average, input rate R_{I} matches output rate R_{O} during sustained operation, such that the total throughput rate of melt system 30 is R_{throughput}=R_{I}=R_{O}. A maximum value of R_{throughput} may, in one embodiment, be 195 cubic centimeters per minute. Controller 18 controls input and output rates R_{I} and R_{O}, respectively, by directing control air valve 17 via control signal cₛ. Control signal cₛ is a function of level signal lₛ, and causes air control valve 17 to direct air to vacuum assembly 24 to maintain adhesive level L_{A} between minimum level Lₘᵢₙ and target level L_{T}. Target level L_{T} is a maximum fill limit selected to avoid overloading melter 102 by depositing unmelted adhesive pellets in a region of melter 102 outside of melting region 106. Minimum level Lₘᵢₙ is a minimum fill level selected to ensure that melting region 106 remains substantially filled with adhesive throughout ordinary operation, rather than emptying between consecutive adhesive replenishments of unmelted adhesive from feed hose 26. Minimum level Lₘᵢₙ and target level L_{T} define the bounds of level range L_{Δ}, a range of adhesive level L_{A} allowed during sustained operation.

Controller 18 directs air through vacuum assembly 24 to replenish adhesive A whenever adhesive level L_{A} falls below minimum level Lₘᵢₙ, ensuring that melter 102 remains substantially full (i.e. within level range L_{A} of level L_{T}) at all times during sustained operation. In some embodiments, controller 18 may direct a fixed duration pulse of air from air control valve 17 to vacuum assembly 24 via air hose 35B in response to any level signal lₛ indicating that adhesive level L_{A} has below minimum level Lₘᵢₙ. This approach replenishes adhesive A by a fixed amount whenever adhesive level L_{A} drops below permissible levels. In an alternative embodiment, controller 18 may instead open air control valve 17 to air hose 35B when level signal lₛ indicates that adhesive level L_{A} has fallen below minimum level Lₘᵢₙ, and close air control valve 17 to air hose 35B only when level signal lₛ indicates that adhesive level L_{A} has risen above target level L_{T}. In either case, controller utilizes adhesive level L_{A} sensed via height h to ensure that melting region 106 remains substantially full of adhesive A during sustained operation of system 10. Vacuum assembly 24, feed hose 26, air control valve 17, controller 18, and level sensor 110 together comprise a feed system that reactively refills melter 102 whenever adhesive level L_{A} leaves level range L_{A}.

Thermoplastic polymer glues such as EVA and metallocene degrade and oxidize when exposed to heat and air for extended periods of time. Adhesives exposed to the heat of melter 102 for more than a discoloration time T_{discolor} may visibly oxidize, causing unsightly adhesive discoloration. A person skilled in the art will recognize that adhesives exposed heated and exposed to air for significantly longer than discoloration time T_{discolor} may begin to form substantial amounts of char on the inside of melter 102, pump 32, and other downstream tubes and receptacles of system 10. Buildup of char material can impede the operation of system 10 by breaking loose and clogging dispenser 34, pump 32, or other flow passages of system 10. Discoloration time T_{discolor} is a time required before adhesive A begins to show visible oxidation when heated in melter 102. Discoloration time T_{discolor} may vary depending on the particular adhesive selected, and on the temperature and geometry of melter 102. Melting system 30 avoids discoloration and char buildup by utilizing melter 102 with a short dwell time T_{dwell} relative to T_{discolor}, Dwell time T_{dwell} is the time required for adhesive to pass through melting volume 106 of melter 102, such that T_{dwell}=Vₘₑₗₜ/R_{throughput}. By enabling a minimum dwell time T_{dwell} (corresponding to a maximum of throughput rate R_{throughput}) less than char time T_{discolor}, melting system 30 allows adhesive A to pass through melting volume Vₘₑₗₜ before adhesive A begins to discolor, and before charring can occur. Melter 102 is constructed such that melting volume Vₘₑₗₜ is small relative to the maximum throughput rate R_{throughput} of melt system 30, such that the minimum dwell time T_{dwell} is less than fourteen minutes. In some embodiments, the minimum dwell time T_{dwell} may be less than five minutes. The small melting volume Vₘₑₗₜ of adhesive A instantaneously being melted in melter 102 also allows melt system 30 to heat up rapidly, reducing startup times for system 10 as a whole. The feed system described above with respect to vacuum assembly 24, feed hose 26, air control valve 17, controller 18, and level sensor 110 obviates the need for manual replenishment of adhesive A in melter 102, enabling feed enables system 10 to operate continuously with a short dwell time T_{dwell} that would be impractical for manually refilled melting systems.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A system for melting adhesive, the system comprising:
a melter with a melting volume for receiving and melting adhesive;
a feed system for supplying unmelted adhesive to the melter;
a pump for pumping melted adhesive from the melter; and
a controller for directing the pump to pump melted adhesive at up to a maximum throughput rate such that a ratio of the melting volume to the maximum throughput rate is a minimum dwell time less than a discoloration time of the adhesive.

2. The system of claim 1, wherein the minimum dwell time is less than fourteen minutes.

3. The system of claim 2, wherein the minimum dwell time is less than five minutes.

4. The system of claim 1, wherein the controller is configured to direct the feed system to replenish adhesive in the melter as a function of adhesive level in the melter.

5. The system of claim 4, wherein the controller directs the feed system to replenish adhesive in the melter when the adhesive level falls below a minimum level.

6. The system of claim 5, wherein replenishing adhesive in the melter comprises feeding a fixed volume of adhesive into the melter.

7. The method of claim 5, wherein replenishing adhesive in the melter comprises feeding adhesive into the melter until the adhesive level rises to a target level.

8. The system of claim 4, further comprising a level sensor configured to sense the adhesive level in the melter.

9. The system of claim 8, wherein the level sensor is an ultra-sonic depth finder.

10. The system of claim 1, wherein the feed system comprises a receptacle, a feed hose, and a vacuum assembly configured for delivering unmelted adhesive from the container through the feed hose into the melter.

11. The system of claim 10, wherein the controller directs the pump and the feed system by commanding an air control valve to provide air to the feed system and to an air motor driving the pump.

12. A system for melting adhesive, the system comprising:
a melter for melting the adhesive, the melter having a minimum adhesive dwell time less than a discoloration time of the adhesive; and
a feed system for automatically filling the melter with unmelted adhesive as a function of adhesive level in the melter.

13. The system of claim 12, wherein the feed system comprises:
a level sensor for sensing when the adhesive level falls below the minimum value; and
a feed system for delivering unmelted adhesive to the melter whenever the level sensor falls below the minimum value.

14. The system of claim 13, wherein the feed system includes a vacuum assembly disposed to draw unmelted adhesive from a dispenser into the melter.

15. The system of claim 12, wherein the minimum adhesive dwell time is less than five minutes.

16. The system of claim 12, wherein the minimum adhesive dwell time is less than two minutes.

17. The system of claim 12, further comprising a melted adhesive pump configured to pump melted adhesive from the melter to a dispenser.

18. A method for melting adhesive, the method comprising:
heating adhesive in a melter with a melting volume;
pumping melted adhesive from the melter at up to a maximum throughput rate such that the melting volume divided by the maximum throughput rate is a minimum dwell time less than a discoloration time of the adhesive;
sensing a level of adhesive in the melter; and
feeding unmelted adhesive into the melter as a function of the sensed adhesive level.

19. The method of claim 18, wherein the minimum dwell time is less than fourteen minutes.

20. The method of claim 19, wherein the minimum dwell time is less than five minutes.

21. The method of claim 18, wherein sensing a level of adhesive comprises sensing when a the level of adhesive drops below a minimum value, and wherein feeding unmelted adhesive into the melter as a function of the sensed adhesive level comprises reactively feeding unmelted adhesive into the melter when the level of the adhesive drops below the minimum value.

22. The method of claim 21, wherein feeding unmelted adhesive into the melter comprises feeding adhesive into the melter until the adhesive level rises to a target level.

23. The method of claim 21, wherein feeding unmelted adhesive into the melter comprises feeding a fixed volume of adhesive into the melter in reaction to the level of the adhesive dropping below the minimum value.

24. The method of claim 18, wherein sensing a level of adhesive in the melter comprises sensing a distance from a level sensor to a surface of the adhesive.

25. The method of claim 18, wherein feeding unmelted adhesive into the melter comprises directing air to a vacuum assembly to draw unmelted adhesive through a feed hose into the melter.
